(19) United States
(12) Patent Application Publication
(10) Pub. No.: US 2011/0289680 A1
(43) Pub. Date: Dec. 1, 2011

(54) Furniture for Adjustment into a Standing Up Assistance Position

(75) Inventor: Erich Sartisohn, Bielefeld (DE)

(73) Assignee: FERDINAND LUSCH GMBH & CO. KG, Bielefeld (DE)

(21) Appl. No.: 13/109,091

(22) Filed: May 17, 2011

(30) Foreign Application Priority Data
May 26, 2010 (DE) 10 2010 021 493.0

(51) Int. Cl. A61G 5/14

(52) U.S. Cl. 5/83.1

(57) ABSTRACT

Furniture includes a sitting face and/or a reclining face, wherein the sitting face and/or the reclining face can be adjusted from a use position into a standing up assistance position and back and wherein the sitting face and/or the reclining face are at least partially raised and/or lowered in the standing up assistance position compared to the use position. The furniture can be provided with a plurality of rollers to move the furniture and fixing means are provided to lock at least one roller and are configured to forcibly lock at least one roller during the adjustment of the sitting face and/or the reclining face from the use position into the standing up assistance position.

The invention relates to furniture with a sitting face and/or a reclining face, the sitting face and/or the reclining face being adjustable from a use position into a standing up assistance position and back and the sitting face and/or the reclining face being at least partially raised and/or lowered in the standing up assistance position compared to the use position.

Furniture of this type is used, in particular, to make it easier for older and ill people to leave the furniture. In particular seating furniture in the form of an armchair is known in the prior art in many different configurations. Generally, in these, the sitting face is raised and pivoted forward, so that the user can easily stand up from the seating furniture. Seating furniture of this type is known, for example, from DE 20 2004 018 898 U1.

However, beds are also known, in which the reclining face can be adjusted with respect to its height and inclination. This can also be used to bring the reclining face into a position which makes it easier for the user to stand up from the bed.

The drawback is that the furniture of the type mentioned at the outset cannot readily be moved by most older or ill users. Known furniture with a standing up assistance position namely requires a rigid and solid position, so that accidents do not occur due to unintentionally moving furniture. The furniture can also only be moved with increased effort by younger and healthy people, for which it is generally necessary for the user to have left the furniture beforehand.

The present invention is therefore based on the object of configuring and developing the furniture mentioned at the outset and described in more detail above in such a way that the furniture as a whole can be moved more easily.

This object is achieved in furniture with the features of the preamble in that a plurality of rollers are provided to move the furniture and in that fixing means are provided to lock at least one roller and are configured to forcibly lock the at least one roller during the adjustment of the sitting face and/or the reclining face from the use position into the standing up assistance position.

Rollers are provided in the furniture according to the invention, with the aid of which the furniture can easily be displaced from one place to another. The displacement of the furniture is particularly easy if it has at least four rollers. The four rollers may be provided on four corners of the furniture. If the furniture has four legs or feet, the four rollers may alternatively or additionally also be provided on the four legs or feet.

The use of rollers and the possibility of the furniture adopting a standing up assistance position are basically two contradictory configurations of furniture. Either the furniture, such as wheelchairs or hospital beds, should be easily displaceable, or leaving the furniture should be made easier for people in a private household.

The invention has recognised that furniture, which can adopt a standing up assistance position, can nevertheless be provided with rollers if fixing means are provided which forcibly lock at least one of the rollers when the sitting face and/or the reclining face is adjusted from the use position into the standing up assistance position. In the use position, the furniture can then be easily displaced, while the furniture in the standing up assistance position ensures a secure standing position. Because of the forcible locking of the at least one roller, accidental faulty operation, which must be reliably ruled out particularly during use by older and ill people, cannot occur either. Faulty operation, particularly in older or ill users, may lead to a fall or the like.

Depending on the furniture, the sitting face or reclining face can be raised or lowered as a whole from the use position in order to adopt the standing up assistance position. However, it may also be provided that the sitting face or reclining face is only partially lowered or raised. This then leads to a pivoting or tilting of the sitting face or reclining face. A corresponding pivoting can then in addition be combined with a raising or lowering of the entire sitting face and/or reclining face in order for a suitable standing up assistance position to be adopted. In addition or alternatively, the sitting face or the reclining face may be simultaneously partially pivoted downward and partly upward.

Finally, a standing up assistance position is basically taken to mean any position of the furniture or the sitting face or the reclining face also allowing older or ill users to leave the furniture easily. The standing up assistance position, however, differs here significantly from the, or at least one, use position of the furniture.

A plurality of components, which form the fixing means, is preferably used to lock and/or release the at least one roller. Even if, in the present case, fixing means are referred to, it is not, however, ruled out that the fixing means, in an exceptional case, can also be formed by a single component.

Moreover, in order to guarantee a secure position of the furniture in the standing up assistance position, not all the rollers of the furniture inevitably have to be locked. Expediently, at least the rollers pivotably mounted on the furniture are locked in the standing up assistance position. In particular if all the rollers are pivotably mounted on the furniture, it is advisable for all the rollers of the furniture to be locked in the standing up assistance position.

In a first configuration of the furniture, the fixing means are configured to at least forcibly release one of the rollers during adjustment of the sitting face and/or the reclining face from the standing up assistance position into the use position. As a result, a high degree of comfort is achieved and it is ensured that the furniture can be displaced in the use position. The at least one roller is thus only locked for as long as the furniture or the sitting face and/or the reclining face is in the standing up assistance position.

In order to achieve a simple and secure actuation of the fixing means to lock and/or release the at least one roller, it may be provided that the fixing means are actuated mechanically, electrically, hydraulically and/or pneumatically. Mechanically actuated fixing means are hardly susceptible to faults. Electrically actuated fixing means, on the other hand, can be very small in configuration. Hydraulically and pneumatically actuated fixing means can transmit high forces. In this case, pneumatically actuated fixing means provide the advantage that the operating means (air) is always available.

The forcible actuation of the fixing means may be ensured in a structurally simple manner in that a fitting is provided, which, during adjustment of the sitting face and/or the reclining face from the use position into the standing up assistance position, comes into contact with the fixing means and actuates the fixing means to lock the at least one roller. Alternatively or additionally, the fitting, during adjustment of the sitting face and/or the reclining face from the standing up assistance position back into the use position, can also come into contact with the fixing means, so the at least one previously locked roller is released again:

For simple actuation of the fixing means with low susceptibility to faults, the latter may comprise a lever mechanism. The lever mechanism then comes into contact with the fitting during adjustment of the sitting face and/or the reclining face from the use position into the standing up assistance position. As a result of this contact, the fixing means are actuated and that at least one roller is locked. Alternatively or additionally, the lever mechanism, during adjustment of the sitting face and/or the reclining face from the standing up assistance position into the use position, can come into contact with the fitting, which then actuates the fixing means to release the at least one roller.

In order to be able to simultaneously lock and/or release more than one roller in a structurally simple manner, the lever mechanism may be coupled to at least two rollers to lock and/or release them. In this case, for the sake of simplicity, it is advisable if the at least two rollers are coupled by a connecting rod to the lever mechanism.

Alternatively or additionally, it may be provided that the lever mechanism is pivoted by contact with the fitting, this pivoting movement being converted into a rotational movement of a component of the fixing means, which in turn brings about the locking and/or release of the at least one roller.

Advantageous synergistic effects are produced when the fitting is provided to adjust the sitting face and/or the reclining face from the use position into the standing up assistance position and/or vice versa. The movement of the fitting required for this can thus also be utilised to actuate the fixing means.

In a further preferred configuration of the furniture, the fitting has a rocker switch to actuate the lever mechanism. When actuating the lever mechanism, the rocker switch goes from a first position into a second position. Owing to the use of the rocker switch, an expedient mutual engagement of the fitting and lever mechanism can be realised in a structurally simple manner.

The rocker switch may be configured to come into contact with the lever mechanism in the first position to lock the roller and to come into contact with the lever mechanism in the second position to release the roller and, to thus be moved into the other position, in each case. As a result, it is possible for the rocker switch, after actuation of the lever mechanism in one direction, to adopt a suitable position in order to then actuate the lever mechanism again in the other direction. The rocker switch can then optionally be moved past the lever mechanism and still reliably arrives, both during the adjustment of the sitting face and/or the reclining face, from the use position into the standing up assistance position and back, to reliably abut against or engage with the lever mechanism to actuate the fixing means to lock and/or release the at least one roller.

The rocker switch may alternatively comprise a spring element, which counteracts the movement of the rocker switch from the first position into the second position with a spring force and which moves the rocker switch back into the first position after the actuation of the lever mechanism of the fixing means. During actuation of the lever mechanism, the rocker switch can thus be moved from a starting position into a deflected position, for example in order to thus be able to be moved past the lever mechanism. The rocker switch, because of the spring force of the spring means, then arrives back in the starting position. This ensures that the rocker switch adopts a suitable position in order to actuate the lever mechanism again.

It is particularly preferred here if the rocker switch is configured to be moved from the first position into a third position by the actuation of the lever mechanism. This movement can then be directed against a spring force of the spring means or a further spring means. As a result of the spring force, the rocker switch can be moved back into the first position after the actuation of the lever mechanism of the fixing means. Regardless of how the lever mechanism is actuated, in other words to lock or to release the at least one roller, the rocker switch always arrives back in its starting position, which ensures a reliable contact or engagement with the lever mechanism during renewed adjustment of the sitting face and/or the reclining face. If necessary, the rocker switch is moved, during adjustment of the sitting face and/or reclining face from the use position into the standing up assistance position, from the first position into the second position, while the rocker switch, during adjustment of the sitting face and/or the reclining face from the standing up assistance position into the use position, is moved from the first position into the third position.

In order to be able to match the interactions between the lever mechanism and the fitting to one another, the lever mechanism may alternatively or additionally have a pivoting arm. During adjustment of the sitting face and/or the reclining face from the use position into the standing up assistance position and/or vice versa, the pivoting arm comes into contact with the fitting, in particular the rocker switch, the pivoting arm firstly being pivoted separately and freely, before the lever mechanism is actuated to lock and/or release the roller. The pivoting of the lever arm alone thus does not yet bring about a locking or release of the at least one roller. The lever arm is, instead, primarily used as a control lever during suitable actuation of the lever mechanism and transmission of the movement of the fitting, in particular the rocker switch, to the fixing means.

If an actuating drive is provided to adjust the sitting face and/or the reclining face from the use position into the standing up assistance position and/or vice versa, so that the adjustment can take place without or only with a small exertion of force by the user, the actuating drive may be coupled to the fixing means in such a way that the activation of the actuating drive forcibly leads to an actuation of the fixing means. In this manner, a synergistic effect is achieved and, if necessary, the actuating drive is also utilised to actuate the fixing means.

The actuating drive and the fixing means may, in this case, be actuated identically here, specifically mechanically, electrically, hydraulically or pneumatically. The various types of actuation provide the advantages already discussed above.

The furniture is preferably seating furniture. This may, for example, be configured as an armchair or sofa. Depending on the application, it may also be preferred for the furniture to be reclining furniture. This may preferably then be configured as a couch or bed.

The invention will be described in more detail below with the aid of drawings showing at least one exemplary embodiment. In the drawings:

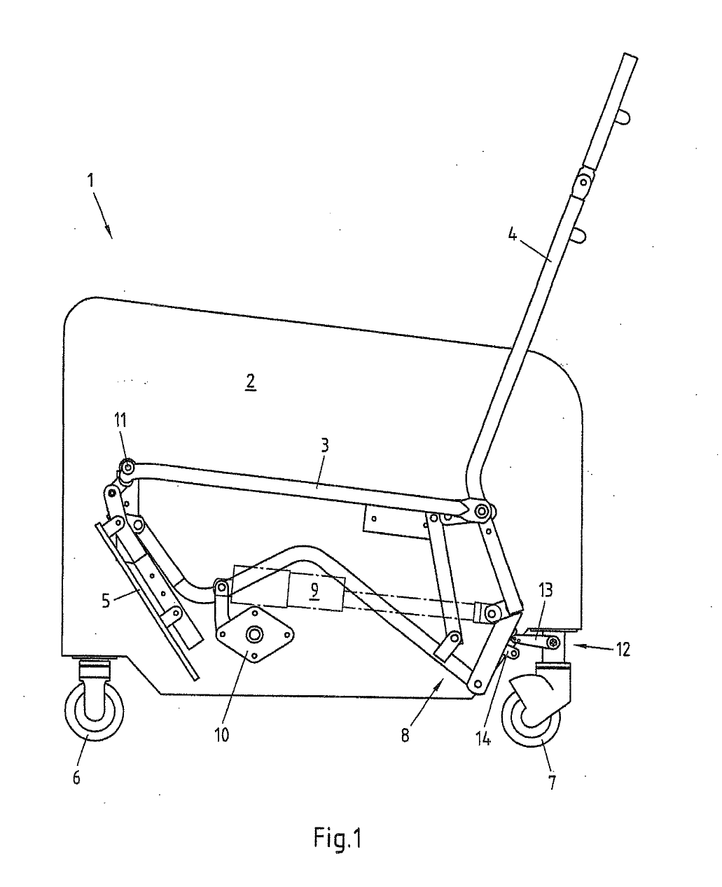

FIG. 1 shows an embodiment of the furniture according to the invention in a use position in a sectional view,

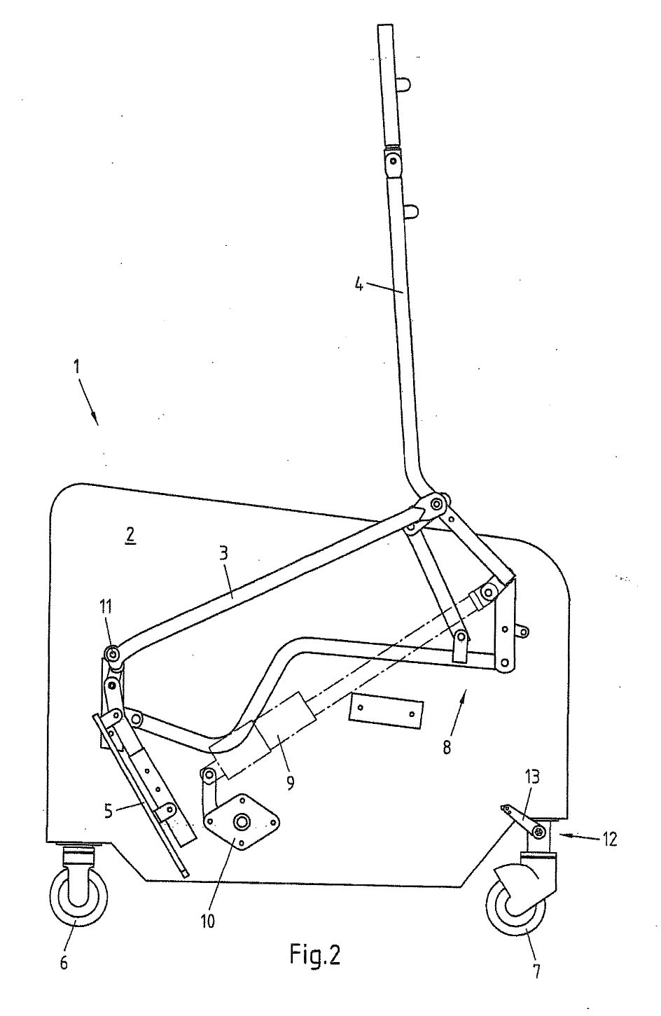

FIG. 2 shows the furniture from FIG. 1 in a standing up assistance position in a sectional view,

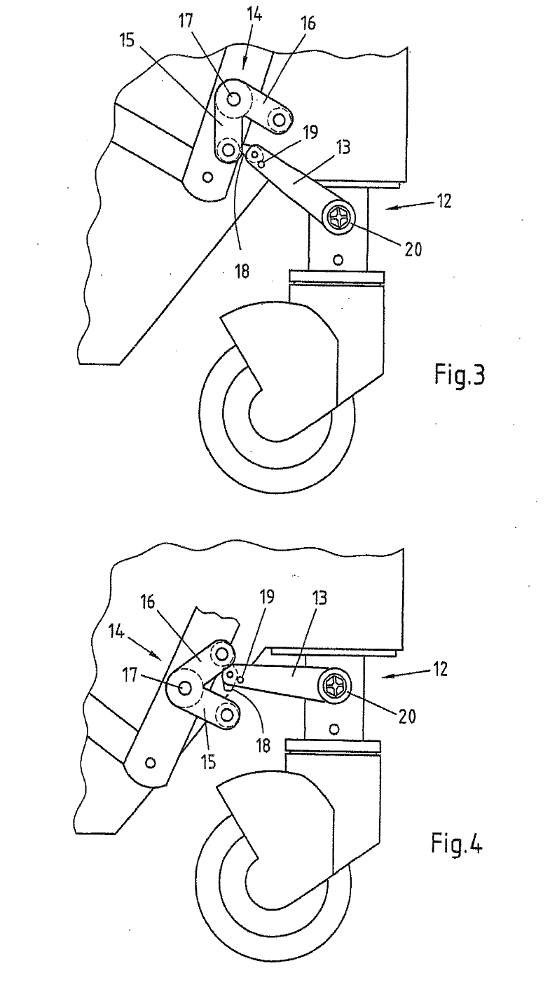

FIG. 3 shows a detail of the furniture from FIG. 1 in a position between the use position and the standing up assistance position in a side view,

FIG. 4 shows the detail of the furniture from FIG. 3 in the use position in a side view and

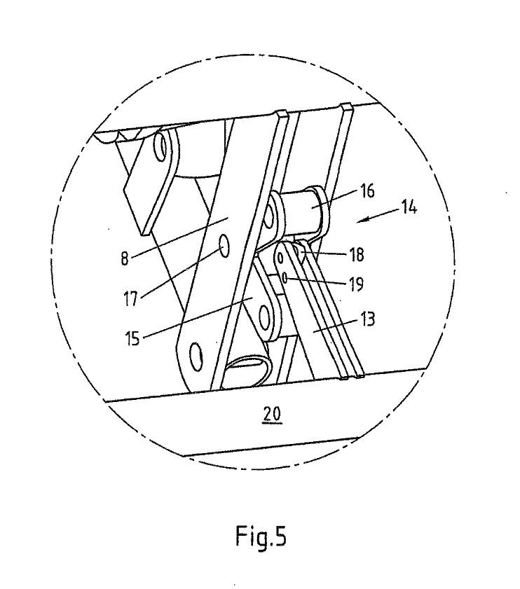

FIG. 5 shows the detail of the furniture from FIGS. 3 and 4 in a perspective view.

In FIG. 1, an item of furniture 1 is schematically shown in the form of seating furniture in a vertical section. The sectional plane, in this case, is arranged, in the viewing direction, behind a front, and therefore not shown, side part of the furniture 1. The side part not shown is identical to the side part 2 shown on the other side of the furniture 1. Provided between the two outer side parts 2 are a seat 3, a backrest 4 and a footrest 5. Furthermore, two rollers 6,7 to displace the furniture 1 are provided on each side part 2. In the shown and to this extent preferred furniture 1, the rear rollers 7 are in each case pivotable in order to facilitate the displacement of the furniture 1. The shown and to this extent preferred furniture 1 is an armchair.

The furniture 1 is shown in FIG. 1 in a use position, which can also be called a sitting position. The seat 3 and therefore the sitting face, not shown in detail but predetermined by the seat 3, can be adjusted in the shown and to this extent preferred furniture from the use position into a standing up assistance position. To adjust the furniture 1 or the seat 3 from the use position into the standing up assistance position, a fitting 8 is provided, which, in the shown and to this extent preferred furniture 1 brings about a pivoting of the backrest 4 relative to the seat 3. In the furniture 1 shown, the fitting 8 is also connected to the seat 3, the backrest 4 and the footrest 5. This allows an adjustment of the furniture 1 from the use position into a reclining position, not shown. To adjust the furniture 1 from the use position into the standing up assistance position, it would, however, basically be sufficient for the fitting 8 to only be connected to the seat 3.

To adjust the shown and to this extent preferred furniture 1 from the use position into the standing up assistance position, the fitting 8 is connected to an actuating drive 9 in the form of an electric drive. The actuating drive 9 is a linear drive. The actuating drive 9 is also connected to a frame 10 of the furniture 1, in particular to the side parts 2 of the furniture 1.

FIG. 2 shows the furniture 1 in the standing up assistance position. In the standing up assistance position, the actuating drive 9 is extended relative to the use position and, as a result, the seat 3, in a rear region, is pivoted upward about a pivot axis 11 in the front region of the seat 3. In this case, the seat 3 is lifted relative to a support in the rear region of the seat 3, upon which the seat 3 rests in the use position. In addition, the seat 3 could also be raised or lowered as a whole, so the standing up assistance position is as comfortable as possible for the user. In the standing up assistance position, the rear rollers 7 are locked, so the furniture 1 cannot be moved in the standing up assistance position, and, in particular, cannot roll away to the rear.

Fixing means 12, which lock the rear rollers 7 in one position, are associated with the rear rollers 7 for this purpose. The fixing means 12, not shown as a whole, in the shown and to this extent preferred furniture 1, comprise a lever mechanism 13, which, during adjustment of the furniture 1 from the use position into the standing up assistance position and during adjustment of the furniture 1 from the standing up assistance position into the use position, engages with the fitting 8. In the first case, the lever mechanism 13 is actuated in a way which leads to a locking of the rear rollers 7. In the second case, the lever mechanism 13 is actuated in a way which leads to a release of the rear rollers 7. In the shown and to this extent preferred furniture 1, the lever mechanism 13, in an upper position, brings about the locking of the rear rollers 7 and, in a lower position, brings about the release of the rear rollers 7.

The fitting 8 has a rocker switch 14, with which the fitting 8 engages with the lever mechanism 13 of the fixing means 12. In the shown and to this extent preferred furniture 1, the rocker switch 14 has two arms 15,16. The two arms 15,16 are oriented in a V-shape with respect to one another. The lower arm 15 of the rocker switch 14, during adjustment of the seat 3 from the use position into the standing up assistance position, comes to abut on the lever mechanism 13, so the lever mechanism 13 is moved from the lower position into the upper position. At the same time, the rocker switch 14 is pivoted from an upper position about a pivot axis 17 into a lower position. This pivoting of the rocker switch 14 means that the rocker switch 14 after the adjustment of the lever mechanism 13 with the fitting 8 can be pivoted further up, without this movement being locked by the lever mechanism 13. This is shown, in particular, in FIG. 3.

Owing to the pivoting of the rocker switch 14 during the adjustment of the seat 3 from the use position into the standing up assistance position, at the same time, the upper arm 16 of the rocker switch 14 arrives in a position relative to the fitting 8, which ensures that the rocker switch 14, during pivoting of the seat 3 from the standing up assistance position into the use position, with the upper arm 16 comes to abut on the lever mechanism 13 of the fixing means 12. As a result, the lever mechanism 13 is moved into the lower position and the rocker switch 14 is moved back into the starting position, which is shown, in particular, in FIG. 4. The movement of the fitting 8 is not locked by the rocker switch 14 abutting on the lever mechanism 13. Furthermore, the lower arm 15 of the rocker switch 14 arrives in a position relative to the fitting 8, in which the lower arm 15, during adjustment of the seat 3 from the use position into the standing up assistance position, comes to abut on the lever mechanism 13.

The lever mechanism 13, in the shown and to this extent preferred furniture 1, comprises a pivoting arm 18, which is pivotably fastened to the lever mechanism 13. The pivoting of the lever arm 18 does not alone yet brings about an actuation of the lever mechanism 13 to lock or release the rear rollers 7. During the adjustment of the sitting face from the use position into the standing up assistance position, the pivoting arm 18 engages with the rocker switch 14. In this case, the pivoting arm 18 is firstly pivoted up, and specifically up to a stop 19. In this position, the pivoting arm 18 is an extension of the lever mechanism 13 in the direction of the rocker switch 14.

If the rocker switch 14 is moved further, because the fitting 8 is moved further in the direction of the standing up assistance position, the movement of the rocker switch 14 is transmitted to the lever mechanism 13 of the fixing means 12. The lever mechanism 13 thus arrives in the upper position. If the rocker switch 14 is adjusted still further in the direction of the standing up assistance position, the rocker switch 14 and the pivoting arm 18 disengage from one another. As a result of gravity, the pivoting arm 18 pivots further down. In this position, the pivoting arm 18 is not, or not a significant, extension of the lever mechanism 13 in the direction of the rocker switch 14. It is thus ensured that the lower arm 15 of the rocker switch 14, without coming into contact with the lever mechanism 13, is moved past the lever mechanism 13, if the sitting face is adjusted back again from the standing up assistance position into the use position. Firstly, the upper arm 16 of the rocker switch 14 then comes into contact with the lever mechanism 13 of the fixing means 12, in order to actuate the latter and move them into the lower position and to release the rear rollers 7.

In FIG. 5, the lever mechanism 13 of the fixing means 12, like the rocker switch 14 of the fitting 8, is shown in a perspective view. The lever mechanism 13 is simultaneously connected to the two rear rollers 7 of the furniture 1 by means of a connecting rod 20. The connecting rod 20 in this case, brings about a locking or a release of the rear rollers 7 of the furniture 1 by means of a torque in one or the other direction.

As an alternative to the above-described two-armed configuration of the rocker switch, this may also have a one-armed configuration. The one arm of the rocker switch would then be pivotably held on the fitting and connected to a spring means. The arm, in a starting position (first position), relative to the fitting, then comes to abut on the lever mechanism of the fixing means when the seat is pivoted from the use position into the standing up assistance position. In this case, the arm moves the lever mechanism upwardly while the arm itself is pivoted down against a spring force. If the seat is further pivoted into the direction of the standing up assistance position, the arm can pass the lever mechanism in an end position (second position). After passing the lever mechanism, the arm of the rocker switch is moved back into the starting position by the spring force. In this starting position relative to the fitting, the arm again comes to abut on the lever mechanism when the seat is adjusted from the standing up assistance position into the use position. In this case, the lever mechanism is moved back into the lower position and the arm of the rocker switch is pivoted up against a spring force until the arm reaches a further end position (third position). In this position, the arm passes the lever mechanism when the seat is further adjusted in the direction of the use position. The arm is then moved back into the starting position as a result of the spring force.

In the shown and to this extent preferred furniture 1, there is no provision for the rocker switch 14 to be pivoted past the lever mechanism 13 of the fixing means 12 during the adjustment of the sitting face from the standing up assistance position into the use position. In the use position, the rocker switch 14, in particular the upper arm 16 of the rocker switch 14, remains in contact with the lever mechanism 13. The same could, alternatively or additionally, also apply to the standing up assistance position. In the standing up assistance position, the lower arm 15 would then abut on the lever mechanism 13 of the fixing means 12. The corresponding arm 15,16 of the rocker switch 14 does not then have to be moved past the lever mechanism 13. Care can then be taken without problems that during the adjustment of the seat 3 from the use position into the standing up assistance position and back, the arm 15,16 provided for this of the rocker switch 14 comes into contact with the lever mechanism 13. In order to nevertheless provide an extensive adjustment between the use position and the standing up assistance position, the lever mechanism 14 [sic] and/or the rocker switch 14 must optionally then be configured to be significantly longer.

1-15. (canceled)

16. A furniture with a sitting face and/or a reclining face, the sitting face and/or the reclining face being adjustable from a use position into a standing up assistance position and back and the sitting face and/or the reclining face being at least partially raised and/or lowered in the standing up assistance position compared to the use position, wherein a plurality of rollers are provided to move the furniture and a fixing means are provided to lock at least one roller, the fixing means being configured to forcibly lock at least one roller during the adjustment of the sitting face and/or the reclining face from the use position into the standing up assistance position.

17. The furniture according to claim 16, wherein the fixing means are configured to forcibly release at least one of the plurality of rollers during the adjustment of the sitting face and/or the reclining face from the standing up assistance position into the use position.

18. The furniture according to claim 16, wherein the fixing means are actuated mechanically, electrically, hydraulically and/or pneumatically in order to lock and/or release at least one of the plurality of rollers.

19. The furniture according to claim 16, further comprising a fitting, which, during the adjustment of the sitting face and/or the reclining face from the use position into the standing up assistance position and/or vice versa, comes into contact with the fixing means and actuates the fixing means to lock and/or release at least one of the plurality of rollers.

20. The furniture according to claim 19, wherein the fixing means comprise a lever mechanism, which, during the adjustment of the sitting face and/or the reclining face from the use position into the standing up assistance position and/or vice versa, is actuated by contact with the fitting.

21. The furniture according to claim 20, wherein the lever mechanism is coupled to at least two of the plurality of rollers to lock and/or release them.

22. The furniture according to claim 19, wherein the fitting is provided to adjust the sitting face and/or the reclining face from the use position into the standing up assistance position and/or vice versa.

23. The furniture according to claim 19, wherein the fitting has a rocker switch to actuate the lever mechanism and the rocker switch is configured to be moved from a first position into a second position by actuating the lever mechanism.

24. The furniture according to claim 23, wherein the rocker switch, in the first position, is configured to come into contact with the lever mechanism to lock at least one of the plurality of rollers and to come into contact with the lever mechanism in the second position to release at least one of the plurality of rollers.

25. The furniture according to claim 23, wherein the rocker switch comprises a spring element which counteracts the movement of the rocker switch from the first position into the second position with a spring force and which moves the rocker switch back into the first position after the actuation of the lever mechanism of the fixing means.

26. The furniture according to claim 25, wherein the rocker switch is configured to be moved into a third position from the first position by the actuation of the lever mechanism, and in that the rocker switch comprises a spring element, which counteracts the movement of the rocker switch from the first position into the third position with a spring force and which moves the rocker switch back into the first position after the actuation of the lever mechanism of the fixing means.

27. The furniture according to claim 23, wherein the lever mechanism has a pivoting arm, which, during the adjustment of the sitting face and/or the reclining face from the use positipn into the standing up assistance position and/or vice versa comes into contact with the rocker switch and in that the pivoting arm is firstly pivoted separately and freely by the contact with the fitting, before the lever mechanism is actuated to lock and/or release at least one of the plurality of rollers.

28. The furniture according to claim 16, wherein an actuating drive is provided to adjust the sitting face and/or the reclining face from the use position into the standing up assistance position and/or vice versa and in that the actuating drive is coupled to the fixing means in such a way that the activation of the actuating drive forcibly leads to an actuation of the fixing means.

29. The furniture according to claim 28, wherein the actuating drive and the fixing means are configured for mechanical, electrical, hydraulic or pneumatic actuation.

30. The furniture according to claim 16, wherein the furniture is seating furniture, in particular an armchair or sofa and/or reclining furniture, in particular a couch or a bed.

31. The furniture according to claim 21, wherein the lever mechanism is coupled to at least two of the plurality of rollers to lock and/or release them by means of a connecting rod.
